(19) United States
(12) Patent Application Publication
(10) Pub. No.: US 2007/0055532 A1
(43) Pub. Date: Mar. 8, 2007

(54) Court electronic filing system

(76) Inventor: Amer Jneid, Laguna Niguel, CA (US)

Correspondence Address: IRELL & MANELLA LLP, 840 NEWPORT CENTER DRIVE, SUITE 400, NEWPORT BEACH, CA, 92660, US

(21) Appl. No.: 11/200,820

(22) Filed: Aug. 9, 2005

(51) Int. Cl. G06Q 99/00

(52) U.S. Cl. 705/1

(57) ABSTRACT

A system and method for electronically filing a court paper. The system may include a court server that provides an electronic filing portal. The portal can be accessed from a remote computer. The court server is coupled to a court relational database and a master database. The court paper can be selected by the user and temporarily stored in the court server. This allows the user to log-off the portal without losing the work performed in creating a filing. The court portal allows the user to electronically file the court paper. Additionally, the portal may allow other users to add documents, exhibits, etc. to the filing. Once the court paper is accepted by the court, the paper is stored in the court relational database and the master relational database.

### BACKGROUND OF THE INVENTION

1. Field of the Invention

The subject matter disclosed generally relates to a method and system for an electronic court filing system.

2. Background Information

There have been developed electronic filing systems for filing papers and documents in courts. Most court electronic filing systems merely allow a user to attach a document to an e-mail or an electronic page. The document is electronically transferred from the user's computer to a court computer. These systems require the user to create the file and/or send the e-mail in a single session. The user cannot log out and log back in to continue the process of developing a file. If a user is interrupted and cannot complete the building and filing of court papers, the user is required to restart the entire process in another session. Additionally, these systems do not allow other user's to participate in building the file. Thus a staff member cannot add exhibits or documents to the file.

It would be desirable to provide an electronic filing system that allows a user, or multiple users, to build and electronically file court papers, exhibits, etc. in multiple sessions. It would also be desirable to provide an electronic filing system that provides a court docket for an attorney that reflects the attorney's entire court activity. Such a system would provide a single integrated system that allows for both electronic filing and attorney docketing functions. It would also be desirable if the electronic filing system allowed for manual process serving through the system. Some present systems allow for electronic service of papers. Electronic process service may be inadequate if the party being served does not have a computer or other electronic access.

Case files, etc. for court cases are typically stored in local court computer systems. Transferring a case from one court to another requires either a physical transfer of a hard copy of the case and/or a transfer of an electronic version of the file. It would be desirable to provide a system that would allow for the transfer of a case from one court to another court in a user friendly fashion. It would also be desirable to provide case statistics that reflect the current status of all cases in a court system.

### BRIEF SUMMARY OF THE INVENTION

A method and system for electronically filing a court paper. The system may include a court server that provides an electronic filing portal. The portal can be accessed from a remote computer. The court server is coupled to a court relational database and a master database. The court paper can be selected by the user and temporarily stored in the court server. The court paper can be electronically filed and accepted by a court. Once the court paper is accepted, the paper can be stored in the court relational database and the master relational database.

### BRIEF DESCRIPTION OF THE DRAWINGS

FIG. 1 is a schematic of a network system that can be used to conduct a business transaction through an electronic communication network;

FIG. 2 is a schematic of a computer of the system;

FIG. 3 is an illustration of a log-in graphical user interface;

FIG. 4 is an illustration of a registration graphical user interface screen;

FIG. 5 is an illustration showing different ? that can be accessed through the system;

FIG. 6 is an illustration of an attorney docket graphical user interface screen;

FIG. 7 is an illustration of an initial case court filing graphical user interface screen;

FIG. 8 is an illustration of a file building (assembly) graphical user interface screen;

FIG. 9 is an illustration of a court filing graphical user interface;

FIG. 10 is an illustration of a process service graphical user interface;

FIG. 11 is an illustration of a submit graphical user interface;

FIG. 12 is an illustration of a court portal graphical user interface;

FIG. 13 is an illustration of a court approval graphical user interface;

FIG. 14 is an illustration of a a court ordered assembly graphical user interface.

FIG. 15 is an illustration of a graphical user interface for high level state court activities;

FIG. 16 is an illustration of a case management graphical user interface;

FIG. 17 is an illustration of a process server graphical user interface;

FIG. 18 is an illustration of a system search graphical user interface;

FIG. 19 is an illustration of a court record graphical user interface;

FIG. 20 is an illustration of a manual court record graphic user interface.

### DETAILED DESCRIPTION

Disclosed is a system and method for electronically filing a court paper. The system may include a court server that provides an electronic filing portal. The portal can be accessed from a remote computer. The court server is coupled to a court relational database and a master database. The court paper can be selected by the user and temporarily stored in the court server. This allows the user to log-off the portal without losing the work performed in creating a filing. Additionally, the portal may allow other users to add documents, exhibits, etc. to the filing. The court portal allows the user to electronically file the court paper. Once the court paper is accepted by the court, the paper is stored in the court relational database and the master relational database. The electronic filing system may include multiple graphical user interfaces (“GUIs”). The GUI's may provide a number of different functions for the filing system.

A plurality of court servers and corresponding court relational databases may be coupled to the master relational database. This allows a case file to be readily transferred from one court database to another court database through a single GUI. A court may transfer an entire case by interacting with a single screen. The common database may also allow for current case statistics for an entire court system. Additionally, the filing system may provide a docket for an attorney showing the attorney's case activity in various courts on a single screen.

The GUI's of the electronic filing system may allow a user to select a process server to manually serve the court paper. The filing system may also have a process server portal that allows a process server to access the court paper. The system may also allow a user to access county documents, such as land deeds, on-line.

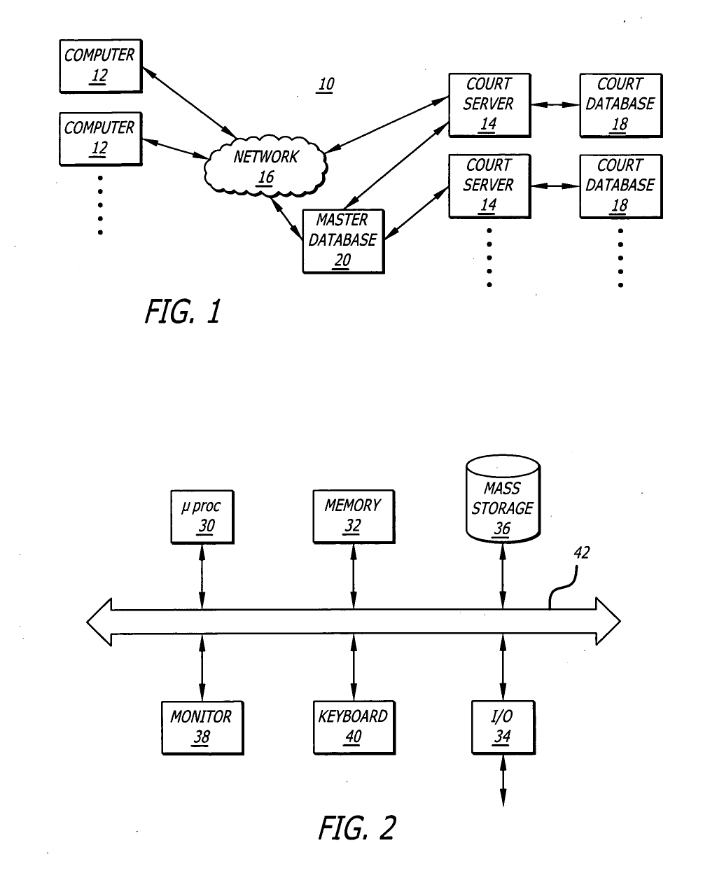

Referring to the drawings more particularly by reference numbers, FIG. 1 shows an embodiment of an electronic filing system 10. The system 10 may include a plurality of remote computers 12 coupled to a plurality of court servers 14 by an electronic communication network 16. The electronic communication network 16 may be a wide area network (WAN) such as the Internet. Accordingly, communication may be transmitted through the network 16 in TCP/IP format. Although a WAN is described, it is to be understood that the network 16 may be a metropolitan area network (MAN), or a local area network (LAN). Additionally, although the internet is described, it is to be understood that the network 16 may be a WAN system that operates in a protocol other than TCP/IP.

The court servers 14 may provide a portal(s) to the electronic filing system that can be accessed through the remote computers 12. Each portal may be a website that is accessed through a uniform resource link (“URL”). The website may contain multiple web pages as is known in the art. Although the remote computers 12 are shown coupled through the communication network 16, it is to be understood that one or more computers 12 may be coupled to the court server 12 in a different manner, such as a direct link. For example, a court may have computers or terminals that are connected to the server 14 by a dedicated link such as a local network.

The system 10 may also include a plurality of court relational databases 18 coupled to a corresponding court server 14. The court servers 14 may be coupled to a master relational database 20. Although the relational databases are shown separate from the servers 14, it is to be understood that the relational databases 18 may be integrated with the databases 18. The court relational databases 18 can store various court records such case files, court papers, etc.

The master relational database 18 may store the court records from each court server 14 coupled to the database 18. The relational database 20 may have a storage hierarchy such that the case files for each court can be identified, accessed and transferred between various court servers 14. The master database 20 may be coupled to the court servers 14 directly or through the network 16.

FIG. 2 shows an embodiment of a computer. The computer includes a processor 30 connected to one or more memory devices 32. The memory device 32 may include both volatile and non-volatile memory such as read only memory (ROM) or random access memory (RAM). The processor 30 is capable of operating software programs in accordance with instructions and data stored within the memory device 32.

The processor 30 may be coupled to a communication port 34, a mass storage device 36, a monitor 38 and a keyboard 40 through a system bus 42. The communication port 34 may include an ETHERNET or other network interface that allows data to be transmitted and received in TCP/IP format. The system bus 42 may be PCI or another conventional computer bus. The mass storage device 36 may include one or more disk drives such as magnetic or optical drives.

Without limiting the scope of the invention the term computer readable medium may include the memory device 32 and/or the mass storage device 36. The computer readable medium will contain software programs in binary form that can be read and interpreted by the computer. In addition to the memory device 32 and/or mass storage device 36, computer readable medium may also include a diskette, a compact disc, an integrated circuit, a cartridge, or even a remote communication of the software program. Although not shown, the servers 12 and databases 14 and 18 may also have a processor(s), memory etc, as is known in the art. The relational databases 18 and 20 may operate a relational database management system (RDBMS) as is known in the art.

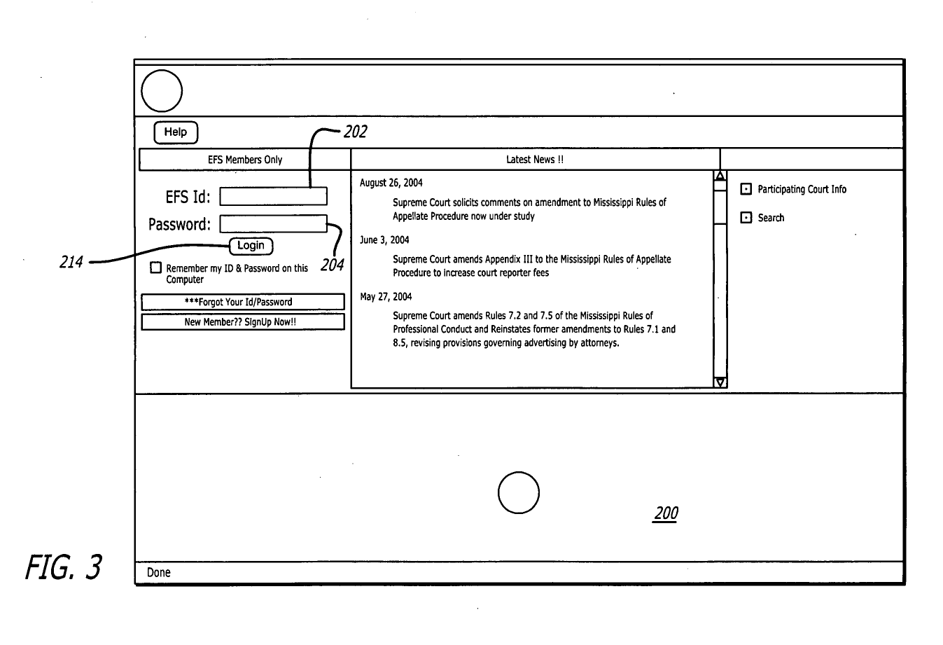

A user can log into the electronic filing system by typing a URL into a browser. This provides access to a website provided by one or more of the court servers 14. FIG. 3 shows an embodiment of a log-in GUI 200 displayed at the remote computer.

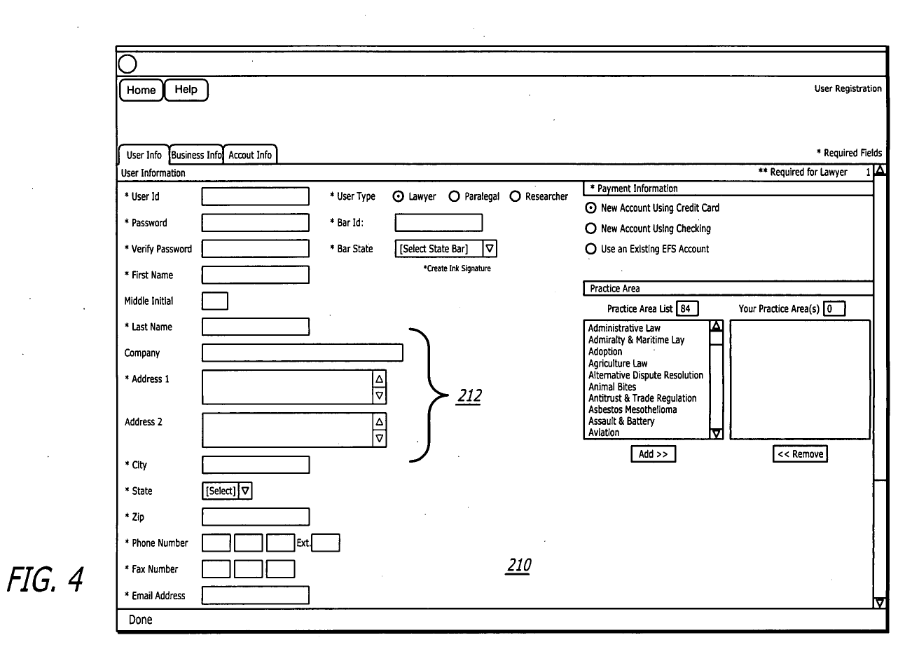

The GUI 200 may have ID 202 and password 204 fields that must be entered to allow a registered user to access the system. FIG. 4 is an embodiment of a registration GUI 210 with various fields 212 that must/may be entered to register a user into the system.

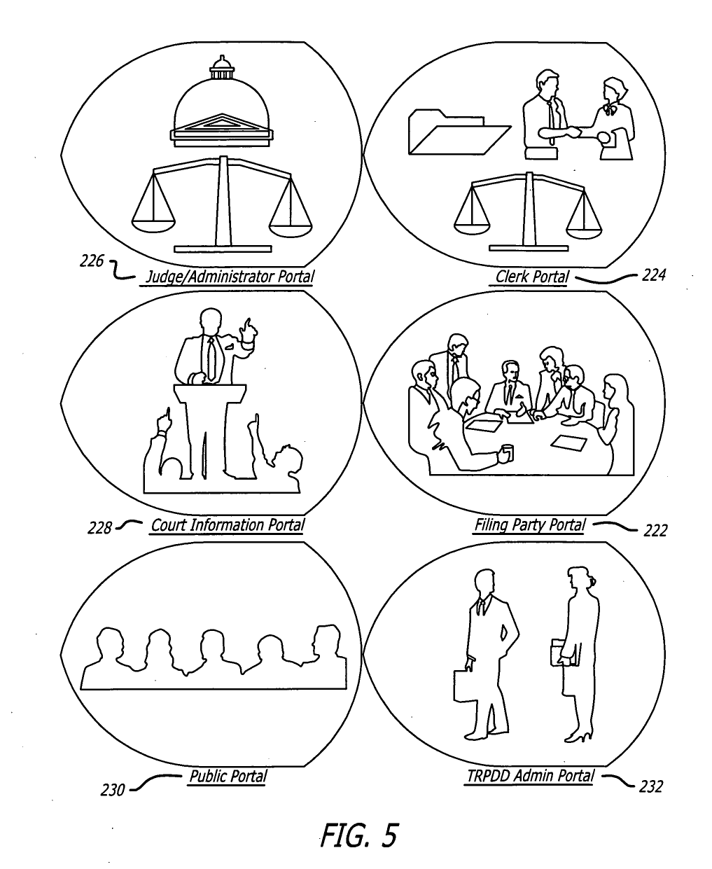

FIG. 5 shows different ports 222, 224, 226, 228, 230 and 232 of the system. The system may automatically map a user to one of the portals based on their log-on information entered through the LOGIN button shown in FIG. 4. The system may include a FILING PARTY PORTAL link 222 that can be selected to enter a portal that allows a user to file a court document or view an attorney docket. The system may include a CLERK PORTAL link 224 that provides access to court personnel to process filed court papers. The JUDGE/ADMINISTRATOR PORTAL line 226 may allow a judge to review case activity or transfer a case.

The COURT INFORMATION PORTAL link 228 may allow a user to view court case information and statistics. The PUBLIC PORTAL link 230 may provide access to court records, etc. to the public. The TRPDD ADMIN PORTAL link 232 may provide access to system administrative functions such as global key searches.

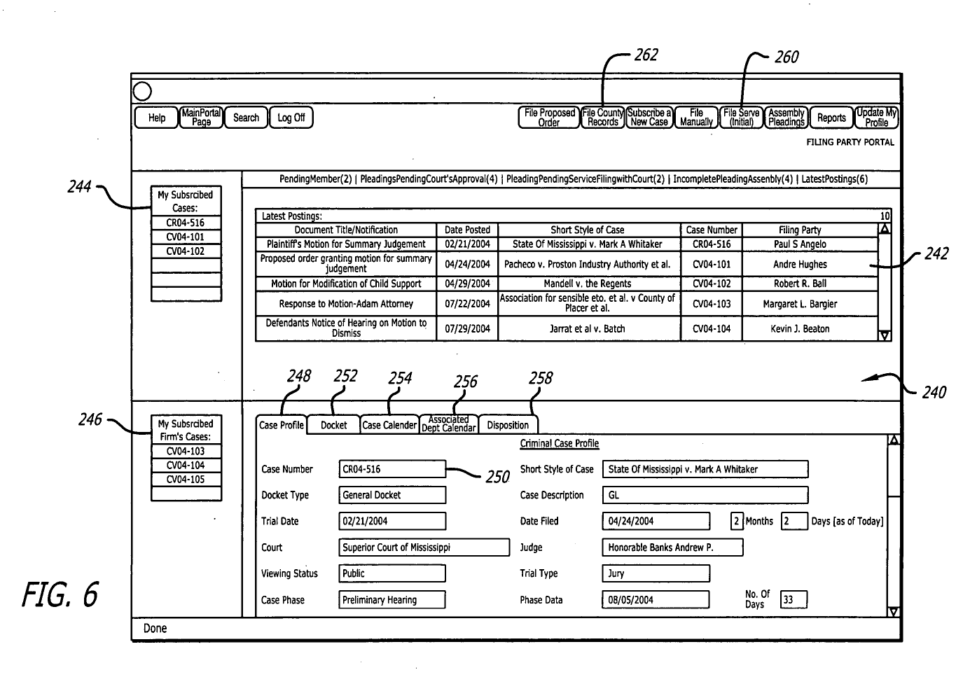

The FILING PARTY PORTAL link 222 may be selected to display an attorney docket GUI 240 shown in FIG. 6. The attorney docket screen 240 includes a field 242 that displays the recent filing activity for all of the attorney's cases. This allows the attorney to readily see the recent court filings for all cases that the attorney is working on. Activity for a specific case can be listed in the field 242 by selecting a case number from field 244. Firm wide cases can be selected from field 246.

A case profile can be provided by selecting button 248. Information on a specific case can be obtained by entering data into in a case number field 250 or highlighting a case from field 242. The docket and case calendar for a case can be displayed by selecting buttons 252 and 254, respectively. The calendar of a court department and disposition of cases can be displayed by selecting buttons 256 and 258, respectively. The user can file a court paper such as a complaint by selecting button 260.

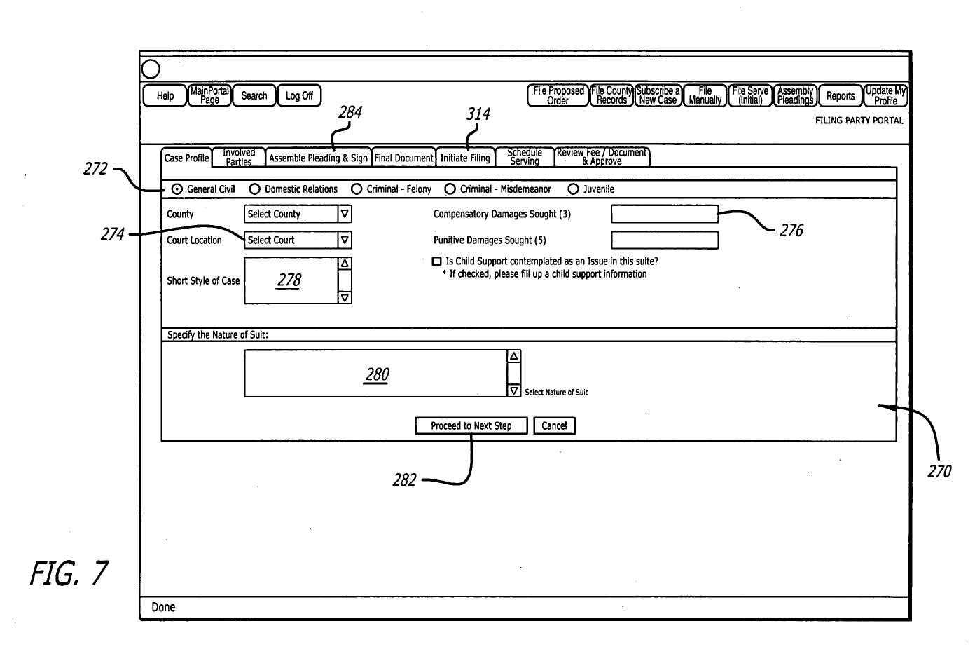

FIG. 7 is an embodiment of an initial filing GUI 270. The GUI 270 may include fields that allow the user to select a type of case 272, a court 274, type of damages 276, a case style 278, and a nature of the suit 280. Some of the fields may include pull down menus that provide a number of options. The user can proceed by selecting the PROCEED TO NEXT STEP button 282. The user can also enter a file building GUI by selecting the ASSEMBLE PLEADING & SIGN button 284.

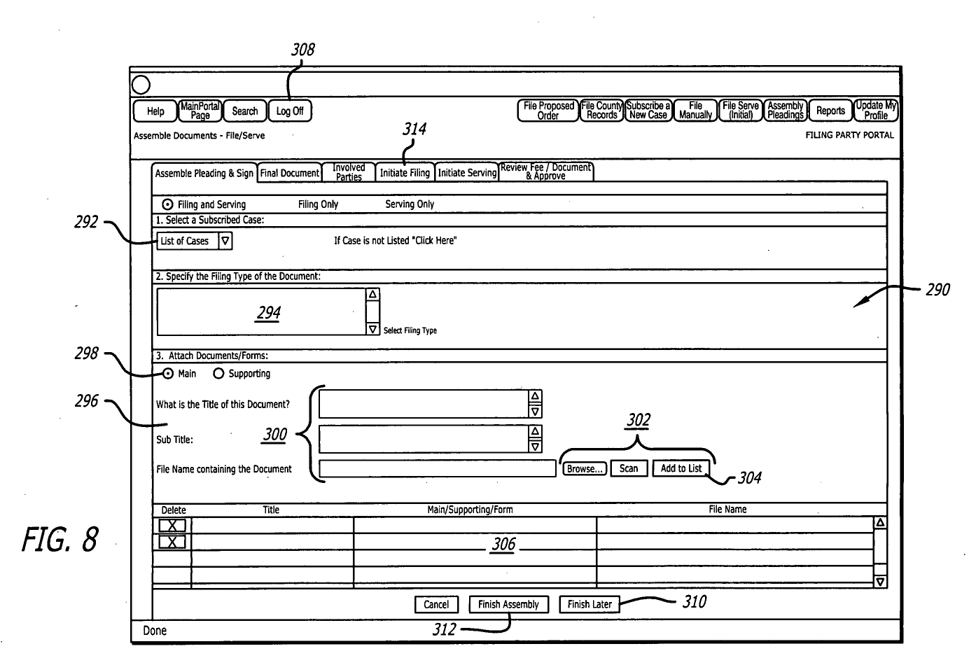

The system may then provide a file building GUI 290 that allows a user to create a file as shown in FIG. 8. The GUI 290 may contain an area 292 with fields to select the case. The GUI 290 may have another area 294 with a field that allows the user to select the type of file. For example, the user may enter PLEADING to indicate that the file is a pleading.

The GUI 296 may have another area that allows the user to attach documents, exhibits, etc. to the file. The area 296 may include a field 298 that allows the user to designate whether the document is the main document or a supporting document. For example, the pleading paper may be designated the main document, while various exhibits may be designated as supporting. The GUI area 296 may include fields 300 and/or graphical buttons 302 that allow the user to search for documents, exhibits, etc. The area 296 may also have a graphical button 304 that can be selected to allow the user to add the document to the file. The selected documents may be listed in field 306. The user can log off a session before filing in the court by selecting the LOG OFF or FINISH LATER buttons 308 and 310.

Even if the user logs off from a session the court server will retain the entered fields and documents. When the user logs back into the system the state of the GUI 290 before the user logged off will be re-displayed to the user. The selected documents will be listed in field 296. The user can add/subtract documents, etc. to the file in the new session. The LOG OFF or FINISH LATER buttons allow a user to assemble court papers in multiple sessions. The user can select a FINISH ASSEMBLY button 312 to finish the assembly of documents. The court server may then automatically converts all of the documents into one format. For example, the server may convert all of the documents into a pdf format.

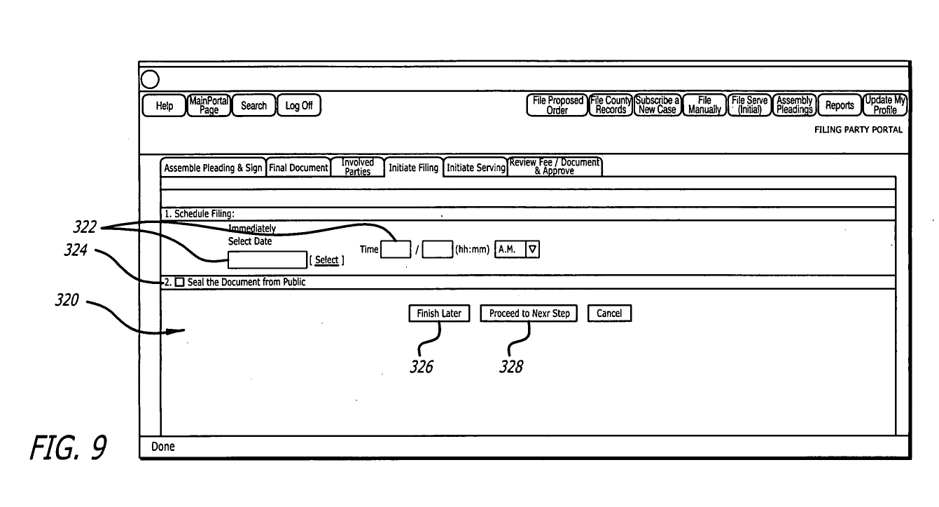

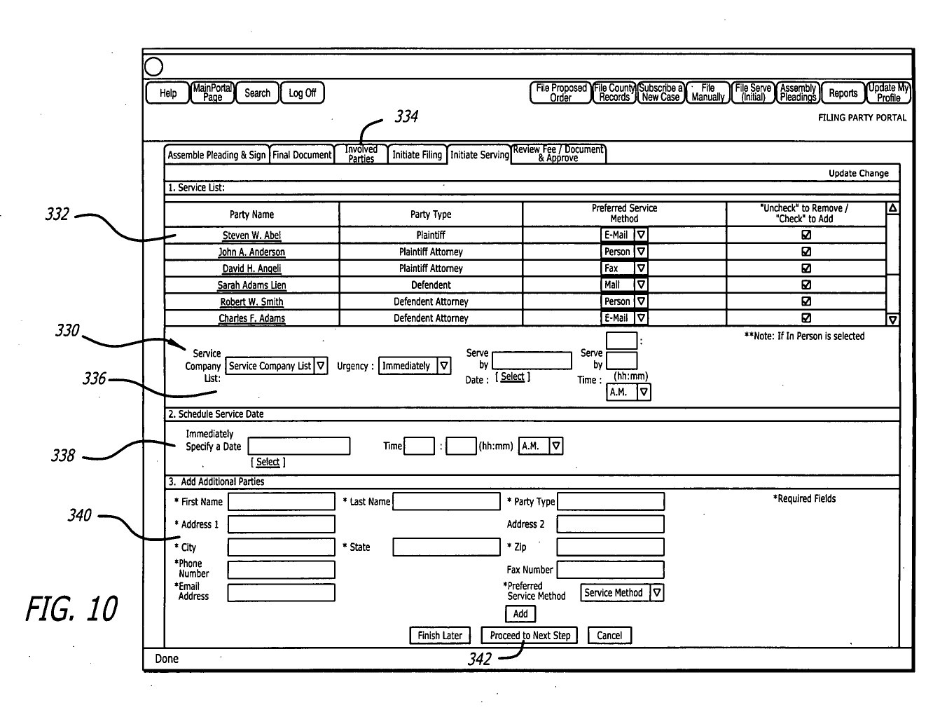

The user can select an INITIATE FILING button 314 when they are ready to file the court paper(s). The system may display the filing GUI 320 shown in FIG. 9 in response to the selection of button 314. The filing GUI 320 provides fields 322 to select the date and time of filing and another field 324 to select whether the filing should be sealed by the court. The GUI 320 includes a FINISH LATER 326 button that allows the user to log off and complete the filing at a later date. Selecting the PROCEED TO NEXT STEP button 328 may cause a service GUI 330 to be displayed as shown in FIG. 10.

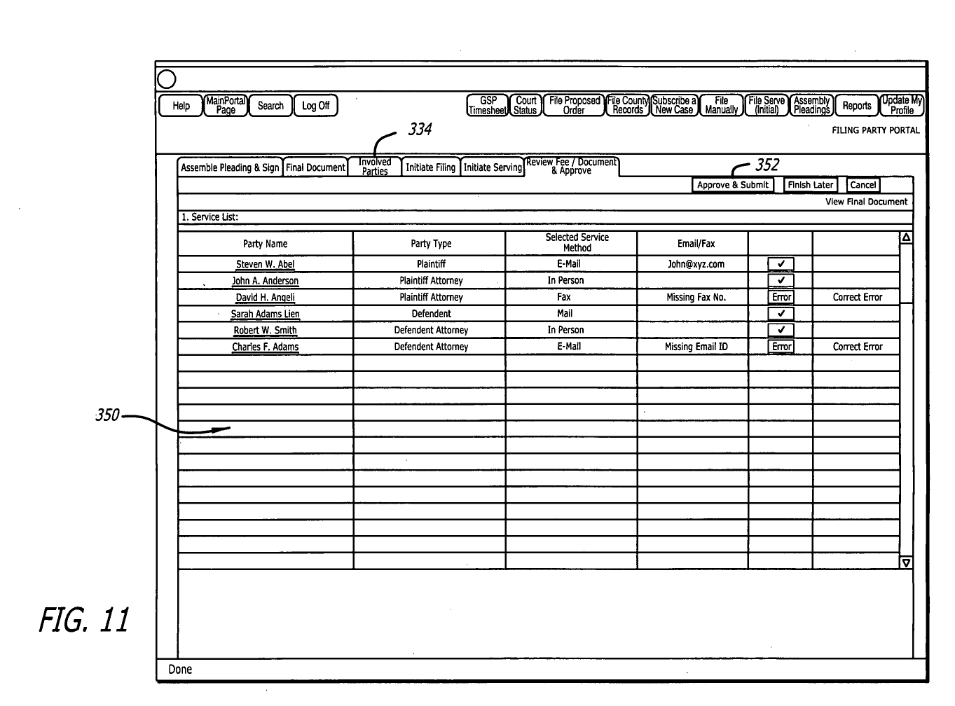

The service GUI 330 may include a Service List field 332 that may be automatically populated with parties entered through a GUI (not shown) selected thru an INVOLVED PARTY button 334. The service GUI 330 may also have fields 336 that allow the user to select the entity that will serve the party(ies), along with the priority and date of service. Fields 338 and 340 for scheduling the service and adding additional parties, respectively, may also be provided by the GUI 330. Selecting the PROCEED TO NEXT STEP button 342 may display the GUI 350 shown in FIG. 11. The GUI 350 provides the cost of service. The user can initiate a filing by selecting the APPROVE & SUBMIT button 352.

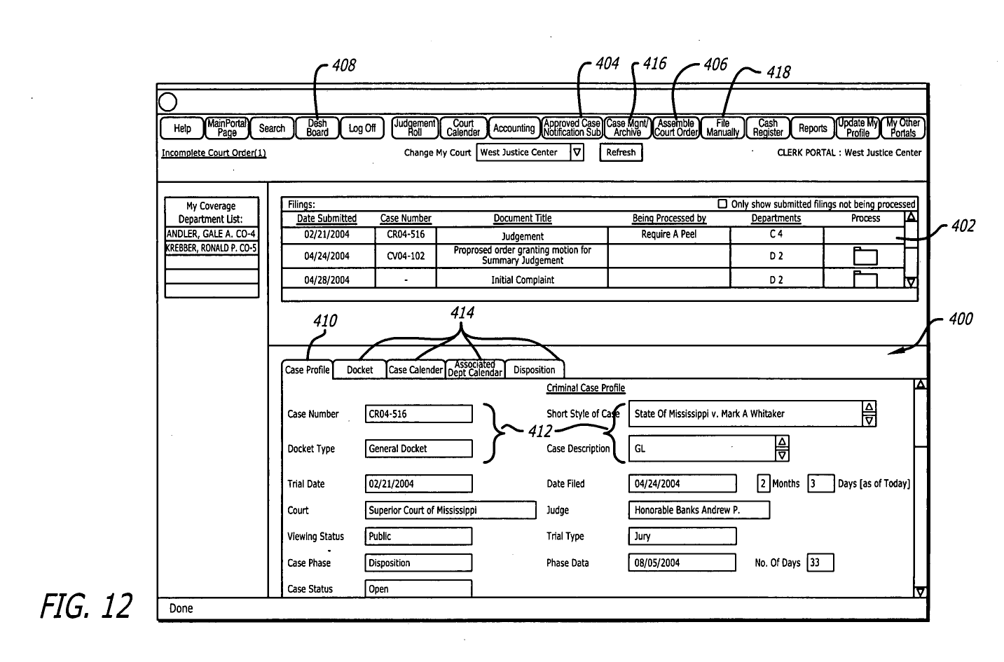

FIG. 12 shows a court portal GUI 400 that can be accessed by personnel, such as a court clerk, in a court system. The court GUI 400 may have a filing field 402 that shows the recent filings in the court. For example, when the user selects the APPROVE & SUBMIT button 352 shown in FIG. 11, the filing is displayed in the filing field 402.

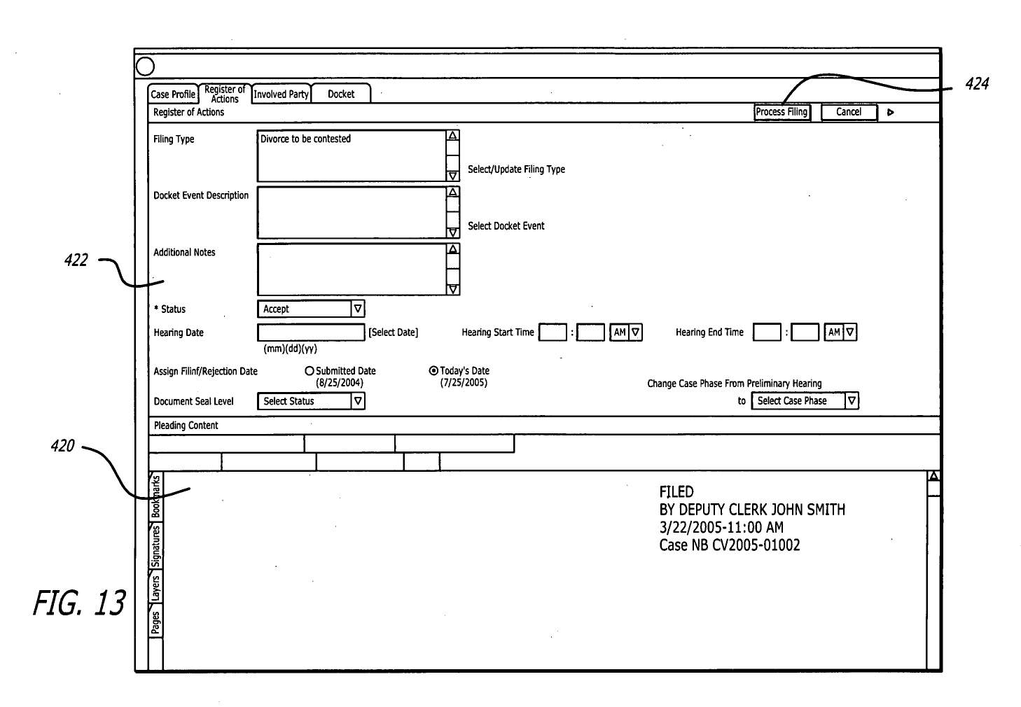

The court personnel can approve or deny the filing by selecting APPROVE CASE NOTIFICATION SUB button 404. FIG. 13 shows a GUI 420 that may be displayed upon selection of button 404. The GUI 420 may have a field 422 that allows the court personnel to approve the filing and a PROCESS FILING button 424 that can be selected to submit the filing. When the SUBMIT button 424 is selected the court server transmits a copy of the filing to the master database. This allows the filing to be accessed by other court servers in the system. Submitting the filing will also cause the filing to appear in the attorney docket GUI recent filing field 242 shown in FIG. 6.

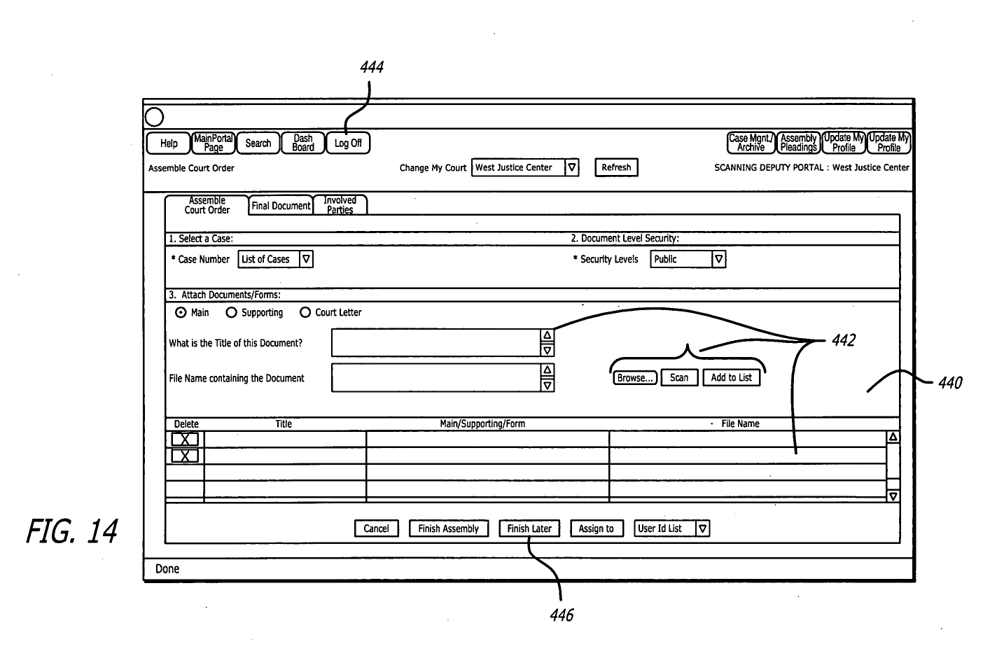

The GUI 400 may include an ASSEMBLE COURTORDER button 406 that can be selected to display the GUI 440 shown in FIG. 14. The GUI 440 may include fields and buttons 442 that are the same or similar to the corresponding fields and buttons shown in FIG. 8. The buttons and fields allow the user to assemble documents for a court order.

Referring to FIG. 14, the GUI 440 also includes LOG OFF and FINISH LATER buttons 444 and 446, respectively, that allows the court personnel to log off a session. The court server will save the selections of the assemble process so that the user can complete the assembly at a later date.

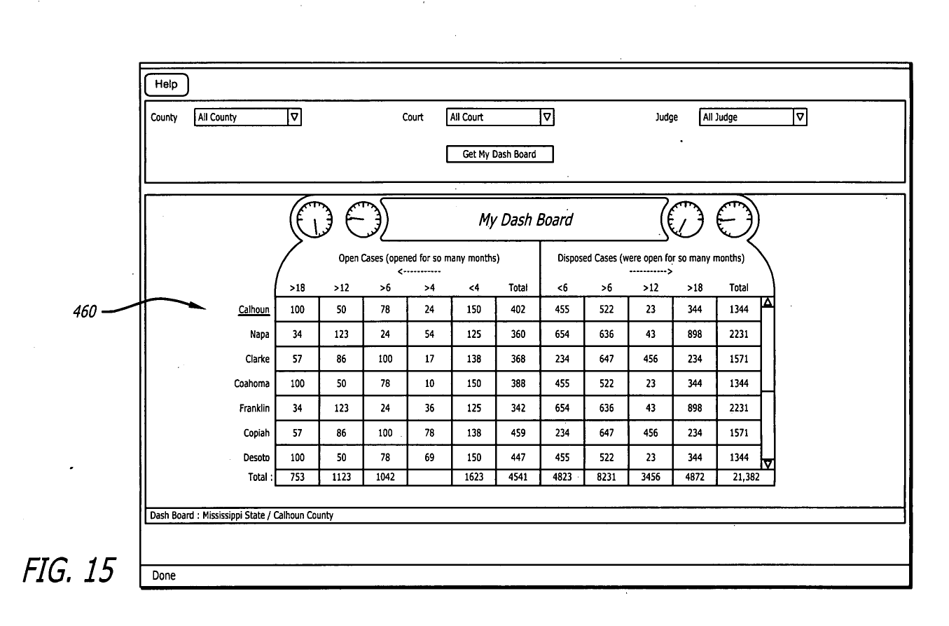

Referring to Fig. 12, the GUI 400 may have a DASHBOARD button 408 that can be selected to display a screen 460 that shows the case activity of all courts within a court system as shown in FIG. 15. The case activity may be automatically compiled by the master database shown in FIG. 1.

Referring to FIG. 12, the GUI 400 may include a CASE PROFILE button 410 that can be selected to create a case profile. The case profile may contain fields 412 that can be filed in by the court personnel. The GUI 400 may also have button 414 for docket, calendar, department calendar and disposition information.

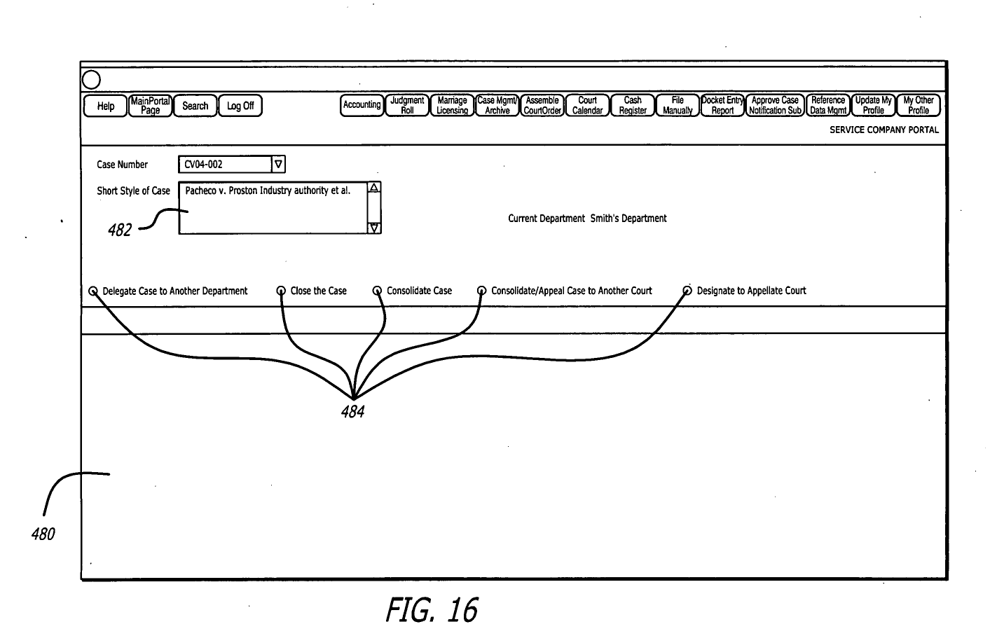

The GUI 400 may include a CASE MGMT/ARCHIVE button 416 that can be selected to display the case management GUI 480 shown in FIG. 16. The case management GUI 480 may include fields 482 that allow the user to designate a case to another court, close a case, etc. Selection of button 484 allow a user to monitor, designate or to consolidate a case. Selection of one of these buttons 484 will cause the court server to transmit the file to the court server of the designated court. The master database is also updated to correlate the file with the designated court.

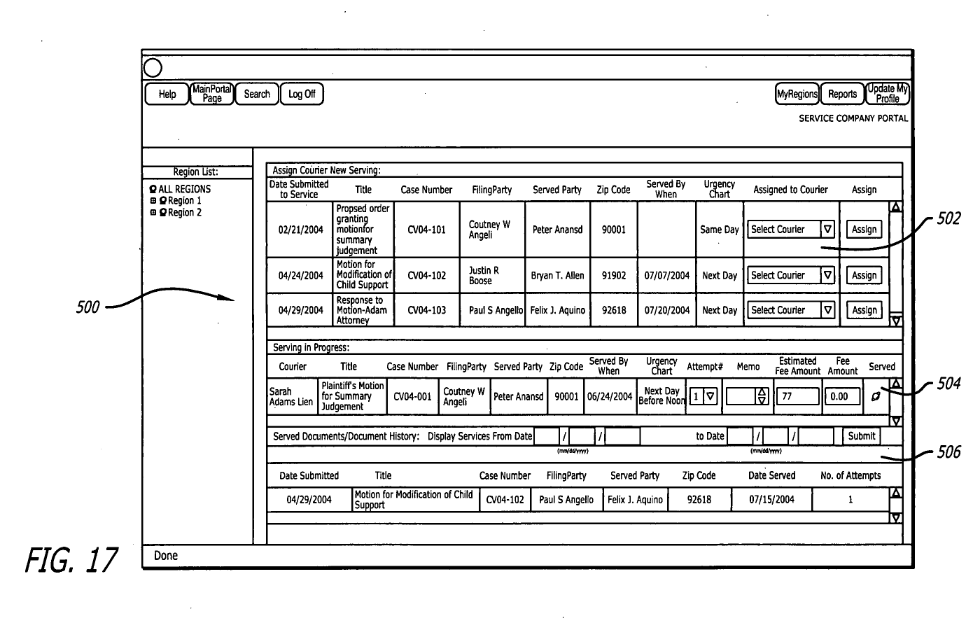

Referring to FIG. 5, the user may select a SERVER PORTAL link 234 to access a process service portal. This portal allows the service companies to retrieve papers that need to be personally served on a party. FIG. 17 is an example of a service GUI 500. The GUI 500 provides an assignment field 502 that allows a service entity to view service assignments. The GUI 500 may also have fields 504 and 506 for viewing/entering information about service performed and services in process, respectively.

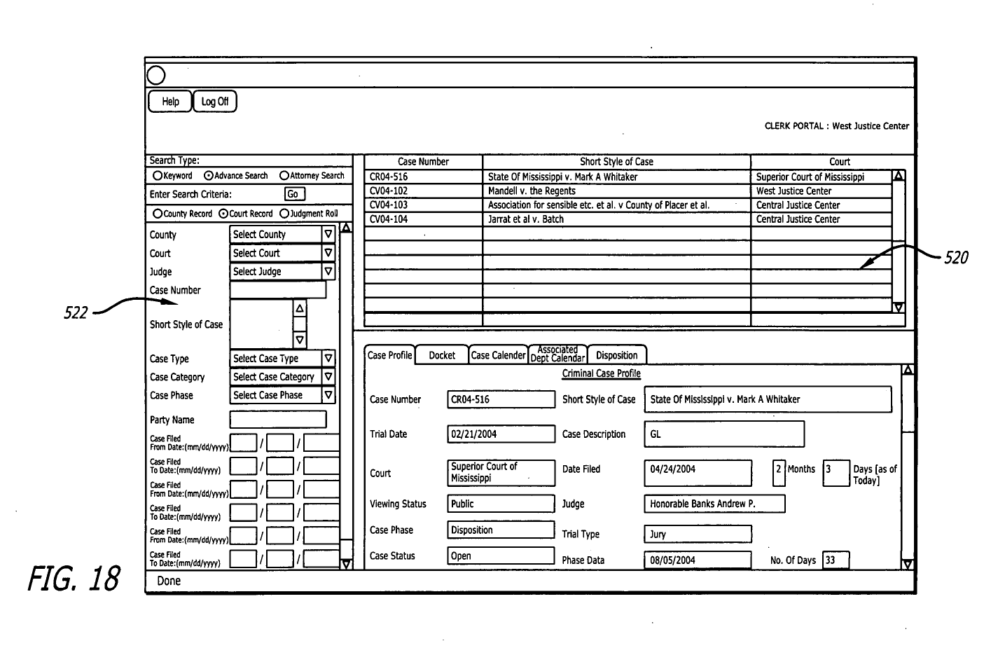

As shown in FIG. 18 the system may have a search GUI 520 that allows a user to conduct system wide searches. The GUI 520 may have field 522 that allows for metadata and/or content searches. The search engine may typically operate in a process by initially searching the local court database and then the master database. This GUI 520 may be received through the TRPDD ADMIN PORTAL link.

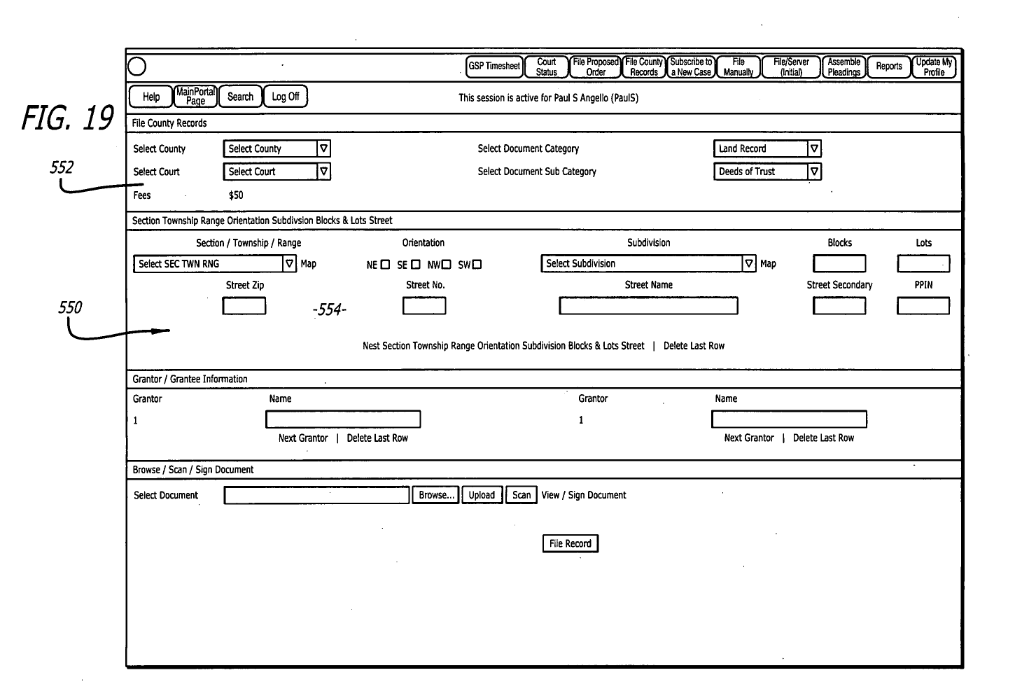

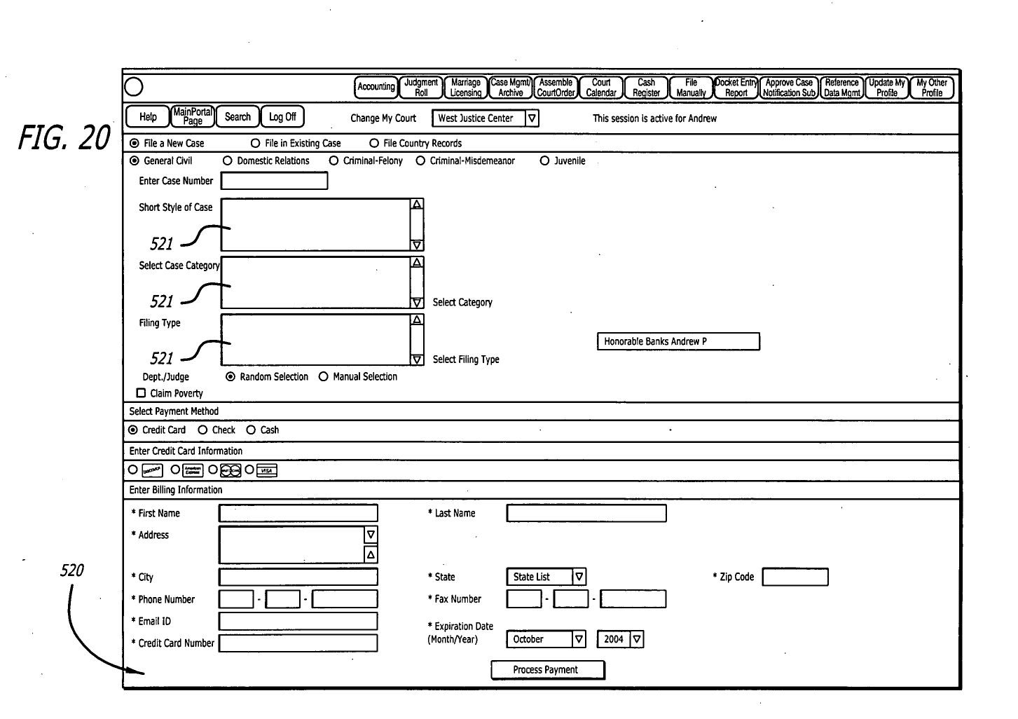

Referring to FIG. 6, the user GUI 240 may include a FILE COUNTY RECORDS button 262 that can be selected to display a records GUI 550 shown in FIG. 19. The records 550 GUI includes fields 552 that allow a user to electronically file a record, such as a land deed, etc., with a court. The GUI 550 may also have a button 554 that allows the user to search the system to find a record. Referring to FIG. 12, the court GUI may include a similar button that can be selected to display the GUI 520 shown in FIG. 20. The GUI 520 may contain fields 521 that can be filled manually or automatically to process the filing of the record.

The system provides an integrated system that allows a user to file, view, transmit, etc. documents and information within a court system.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A system that allows for an electronic filing of a court paper in a court, comprising:
a first remote computer that displays a plurality of graphical user interfaces that allow a user to log-on and log-off from a session, at least one of said graphical user interfaces allows the user to select a court paper and file said court paper; and,
a court server that maintains a file of said selected court paper even when the user has logged-off from a session without filing said court paper.

2. The system of claim 1, wherein said court paper is converted into a common format.

3. The system of claim 2, wherein said format is a pdf format.

4. The system of claim 1, wherein at least one of said graphical user interfaces allows a user to select a group of users that can select said court.

5. The system of claim 1, wherein at least one graphical interface includes a Finish Later button.

6. The system of claim 1, further comprising a court relational database coupled to said court server that stores said court paper when said court paper has been accepted by the court.

7. The system of claim 1, further comprising a master relational database that is coupled to said court server and stores said court paper.

8. The system of claim 1, wherein at least one graphical user interface allows a user to select a service of process for said court paper.

9. The system of claim 1, further comprising a process server portal.

10. The system of claim 1, further comprising at least one graphical user interface that provides a court docket for the user.

11. The system of claim 1, wherein said graphical user interfaces are provided by said host server.

12. A computer program storage medium that can cause a filing of a court paper in a court from a remote computer, comprising:
a computer readable storage medium that causes a first remote computer to present a plurality of graphical user interfaces that allow a user to log-on and log-off from a session, at least one of said graphical user interfaces allows the user to select a court paper and file said court paper, and a court server to maintain a file of said selected court paper even when the user has logged-off from a session without filing said court paper.

13. The storage medium of claim 12, wherein said storage medium causes said court paper to be converted into a common format.

14. The storage medium of claim 13, wherein said format is a pdf format.

15. The storage medium of claim 12, wherein at least one of said graphical user interfaces allows a user to select a group of users that can select said court paper.

16. The storage medium of claim 12, wherein at least one graphical interface includes a Finish Later button.

17. The storage medium of claim 12, wherein at least one graphical user interface allows a user to select a service of process for said court paper.

18. The storage medium of claim 12, wherein said storage medium causes said remote computer to present a process server portal.

19. The storage medium of claim 12, wherein said computer program causes said remote computer to present at least one graphical user interface that provides a court docket for the user.

20. A method for a filing a court paper in a court, comprising:
logging-on to an electronic filing portal from a remote computer;
selecting a court paper;
logging-off the electronic filing portal; and,
saving the selected court paper in a court server.

21. The method of claim 20, further comprising logging on to the electronic filing portal, and filing the court paper.

22. The method of claim 21, further comprising converting the court paper into a common format.

23. The method of claim 22, wherein the common format is a pdf format.

24. The method of claim 22, further comprising entering a group of users that can select the court paper.

25. The method of claim 21, wherein the court paper is filed by selecting a Finish Later button.

26. The method of claim 21, further comprising storing the court paper in a court relational database when the court paper has been accepted by the court.

27. The method of claim 26, further comprising storing the court paper in a master relational database when the court paper has been accepted by the court.

28. The method of claim 20, further comprising selecting a process server for the court paper.

29. The method of claim 28, further comprising logging on to a process server portal to obtain the court paper.

30. The method of claim 20, further comprising presenting at least one graphical user interface that provides a court docket for the user.

31. A system that allows for a filing of a court paper in a court, comprising:
a first court server that provides an electronic filing portal;
a first remote computer that can access said electronic filing portal to file a court paper;
a first court relational database coupled to said first host server, said first host relational database stores said filed court paper; and,
a master relational database coupled to said first host server, said master relational database stores said filed court paper.

32. The system of claim 31, wherein said court paper is stored in said first court relational database when said court paper is accepted by the court.

33. The system of claim 32, wherein said court paper is stored in said master relational database when said court paper is accepted by the court.

34. The system of claim 31, further comprising a second court server coupled to said first remote computer and said master relational database, and a second court relational database coupled to said second court server.

35. The system of claim 34, further comprising a graphical user interface that transfers a case file from said first court relational database to said second court relational database.

36. The system of claim 31, further comprising a graphical user interface that provides statistics of case files stored in said master relational database.

37. The system of claim 31, further comprising a second remote computer coupled to said first court server to access a process server portal.

38. The system of claim 31, wherein said electronic filing portal allows access to county records stored in said first court relational database.

39. A system that allows for a filing of a court paper in a court, comprising:
first court server means for providing an electronic filing portal;
first remote computer means for accessing said electronic filing portal to file a court paper;
first court relational database means for storing said filed court paper; and,
master relational database means for storing said filed court paper.

40. The system of claim 39, wherein said court paper is stored in said first court relational database means when said court paper is accepted by the court.

41. The system of claim 40, wherein said court paper is stored in said master relational database means when said court paper is accepted by the court.

42. The system of claim 39, further comprising a graphical user interface that allows a user to transfer a case file from said first court relational database means to a second court relational database coupled to a second court server.

43. The system of claim 39, further comprising a graphical user interface that provides statistics of case files stored in said master relational database means.

44. The system of claim 39, further comprising second remote computer means for accessing a process server portal of said first court server means.

45. The system of claim 39, wherein said electronic filing portal allows access to county records stored in said first court relational database means.

46. The system of claim 39, further comprising at least one graphical user interface that provides a court docket for the user.

47. A method for a filing of a court paper in a court, comprising:
selecting a court paper at a remote computer;
filing the court paper at a court server;
accepting the court paper at the court server;
storing the court paper in a court relational database; and,
storing the court paper in a master relational database.

48. The method of claim 47, further comprising transferring a case file from the master relational database to a second court relational database.

49. The method of claim 47, further comprising providing statistics of case files stored in the master relational database to the first remote computer.

50. The method of claim 47, further comprising accessing a process server portal at a second remote computer.

51. The method of claim 47, further comprising accessing county records stored in the first court relational database.

52. A system that allows for accessing a county record, comprising:
a court server that provides an electronic portal;
a court relational database coupled to said court server, said court relational database stores a plurality of county records; and,
a remote computer that can access said electronic filing portal to access said county records.

53. The system of claim 52, wherein said county record includes a deed.

54. A system that allows for accessing a county record, comprising:
court server means for providing an electronic portal;
court relational database means for storing a plurality of county records; and,
remote computer means for accessing said electronic filing portal to access said county records.

55. The system of claim 54, wherein said county record includes a deed.

56. A method for accessing a county record, comprising:
storing a plurality of county records in a court relational database;
logging onto an electronic portal provided by a court server from a remote computer; and,
accessing the county records through the electronic portal.

57. The method of claim 56, wherein the county record includes a deed.

58. A system that allows for facilitating a process service, comprising:
a first court server that provides a process server portal;
a court relational database coupled to said court server, said court relational database stores a court paper; and,
a remote computer that can access said process server portal and receive said court paper.

59. The system of claim 58, wherein said process server portal provides an event log.

60. A system that allows for accessing a county record, comprising:
court server means for providing a process server portal;
court relational database means for storing a court paper; and,
remote computer means for accessing said process server portal and receiving said court paper.

61. The system of claim 60, wherein said process server portal provides an event log.

62. A method for facilitating a process service, comprising:
storing a court paper in a court relational database;
accessing a process server portal provided by a court server from a remote computer; and,
receiving the court paper at the remote computer.

63. The method of claim 62, further comprising providing an event log.

64. A system that provides an attorney docket, comprising:
a first court server that provides an electronic filing portal;
a court relational database coupled to said court server, said court relational database stores an attorney docket for a user; and,
a first remote computer that can access said electronic filing portal and display said attorney docket.

65. The system of claim 64, wherein said attorney docket includes a case profile field.

66. A system that provides an attorney docket, comprising:
court server means for providing an electronic filing portal;
court relational database means for storing an attorney docket of a user; and,
remote computer means for accessing said electronic filing portal and displaying said attorney docket.

67. The system of claim 66, wherein said attorney docket includes a case profile field.

68. A method for reviewing an attorney docket, comprising:
storing an attorney docket of a user in a court relational database;
accessing an electronic filing portal provided by a court server; and,
reviewing the attorney docket through the electronic filing portal from a remote computer; and,

69. The system of claim 68, wherein the attorney docket includes a case profile field.
